(19) United States
(12) Patent Application Publication
(10) Pub. No.: US 2014/0042341 A1
(43) Pub. Date: Feb. 13, 2014

(54) APPARATUSES AND METHODS FOR CURING UV FINGERNAIL GEL WITH MINIMAL UV EXPOSURE

(71) Applicant: PARK GLOBAL HOLDINGS, LLC, Clifton, NJ (US)

(72) Inventors: Fa Young Park, Clifton, NJ (US); Yu Chul Choi, Clifton, NJ (US)

(73) Assignee: PARK GLOBAL HOLDINGS, LLC, Clifton, NJ (US)

(21) Appl. No.: 13/834,825

(22) Filed: Mar. 15, 2013

Related U.S. Application Data
(60) Provisional application No. 61/684,031, filed on Aug. 16, 2012.
(60) Provisional application No. 61/682,500, filed on Aug. 13, 2012.

(51) Int. Cl. B05D 3/06

(52) U.S. Cl. CPC B05D 3/067
USPC 250/492.1

(57) ABSTRACT

A UV curing device that includes a UV light source, a lens positioned proximate the UV light source, control means for actuating the UV light source; and safety means for minimizing inadvertent pointing of a UV light beam from said UV curing device into an eye. The UV curing device is used to sequentially, separately and individually apply UV light to cure UV gel on each of a plurality of fingernails.

### CROSS-REFERENCE TO RELATED APPLICATIONS

The present application claims priority to U.S. Provisional Patent Application Ser. No. 61/682,500, filed Aug. 13, 2012, and U.S. Provisional Patent Application Ser. No. 61/684,031, filed Aug. 16, 2012, the disclosures of which are incorporated by reference herein in their entirety.

### FIELD OF THE INVENTION

The present invention relates to the field of curing devices, more specifically to novel handheld apparatuses for curing ultraviolet (“UV”) gel on fingernails and methods for using same.

### BACKGROUND OF THE INVENTION

The application of UV gel to fingernails is an increasingly popular method of decorating fingernails in place of ordinary fingernail enamel. In this process, a salon technician spreads a layer of UV gel on a fingernail and then sets the finger under a UV light which cures the gel. The UV light is typically positioned on the top surface of a tunnel structure that is large enough to receive a user's hand therein. The user puts her hand into the opening of the tunnel structure so that gel on several fingers may be cured simultaneously. Normally, several gel layers are required. For example, a base coat of UV gel is followed by a pigment-containing UV gel coat and then one or more sealing UV gel coats are applied thereafter.

In addition to the time and expense associated with UV applications, there are potential health risks as well. The repeated exposure of the entire hand to UV waves may pose risks to a user, especially if she receives frequent UV fingernail treatments. Further, UV light exposure poses a vision hazard if directed into a user's eyes.

Moreover, the tunnel structures that are typically used in salons are rather large, occupying scarce tabletop space available to a manicurist.

Additionally, a consumer may want to purchase and use UV gels but does not want the commercial type UV curing light, or she may want the ability to apply UV gel while on the run, and cure it conveniently.

### SUMMARY OF THE INVENTION

The present invention is directed to a UV curing device that includes a UV light source, a lens positioned proximate the UV light source, control means for actuating the UV light source; and safety means for minimizing inadvertent pointing of a UV light beam from said UV curing device into an eye. The present invention is also directed to a method of sequentially, separately and individually applying UV light to cure UV gel on each of a plurality of fingernails, using the UV curing device.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 is an exploded view of a UV curing device according to an embodiment of the invention;

FIG. 2 is a top perspective view of the UV curing device illustrated in FIG. 1, as inserted in a support base and in use;

FIG. 3 is a side elevational view of the UV curing device illustrated in FIG. 1, with a partial sectional view;

FIG. 4 is top perspective view of a UV curing device according to a second embodiment of the invention, and includes a top plan view of the UV curing device;

FIG. 5 is top perspective view of a UV curing device according to a third embodiment of the invention, and includes a top plan view of the UV curing device; and

FIG. 6 is a side elevational view of a UV curing device according to a fourth embodiment of the invention.

### DETAILED DESCRIPTION OF THE INVENTION

Detailed embodiments of the present invention are disclosed herein. It should be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, and some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as examples for teaching one skilled in the art to variously employ the present invention.

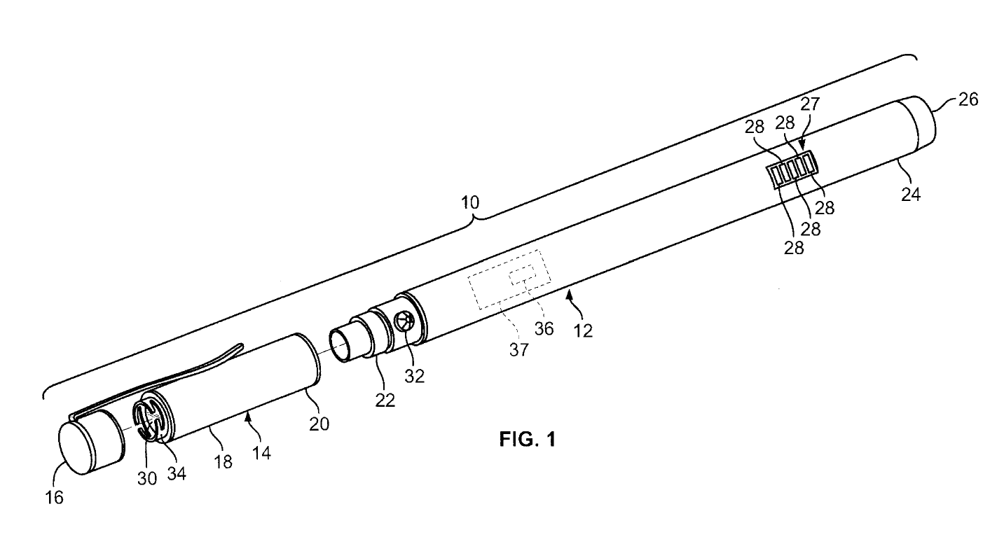

Reference is made to FIGS. 1-3, which illustrate a first embodiment of the present invention that is in the general shape of a pen, or other, similarly-sized handheld objects. A UV curing device 10 includes a power supply section 12, a UV light source section 14 and a cover 16 that is secured to a first end 18 of the UV light source section 14. The UV light source section 14 has a second end 20 that is distal to the cover 16. The power supply section 12 has a first end 22 and a second end 24.

In one embodiment, the power supply section 12 and UV light source section 14 are separate pieces, wherein the first end 22 of the power supply section 12 securely and removably engages the second end 20 of the UV light source section 14 (see FIG. 1). In one embodiment, the first end 22 of the power supply section 12 and the second end 20 of the UV light source section 14 are mateably threaded so as to threadably engage each other. In another embodiment, the power supply section 12 and the UV source section 14 are formed as one unit, i.e., the UV curing device 10 (excluding the cap 16 thereof) has one-piece construction.

In one embodiment, the power supply section 12 contains one or more rechargeable batteries, and the second end 24 of the power supply section 12 includes an AC charging jack (not shown) which is covered by an end cap 26, as illustrated in FIGS. 1-3. The end cap 26 is removed to expose the AC charging jack, and the second end 24 of the power supply section 12 is inserted into a charger base (not shown) to recharge the battery. In another embodiment, an electric adaptor cord (not shown) is used to recharge the battery from a standard electric socket. In yet another embodiment, the AC charging jack is located proximate the first end 22 of the power supply section 12 (not shown), wherein the power supply section 12 and the UV source section 14 are separated in order to access the AC charging jack and recharge the battery. In still another embodiment, the power supply section 12 contains one or more conventional, one-time use batteries rather than rechargeable batteries, and the end cap 26 on the second end 24 of the power supply section 12 may be removed to insert and replace such batteries therein.

In one embodiment, the power supply section 12 includes a battery life/charging status indicator. As illustrated in FIGS. 1-3, an indicator 27 may include multiple “bars” 28 that may be illuminated by, e.g., one or more LED lights or LCD displays, according to the battery life/charging status.

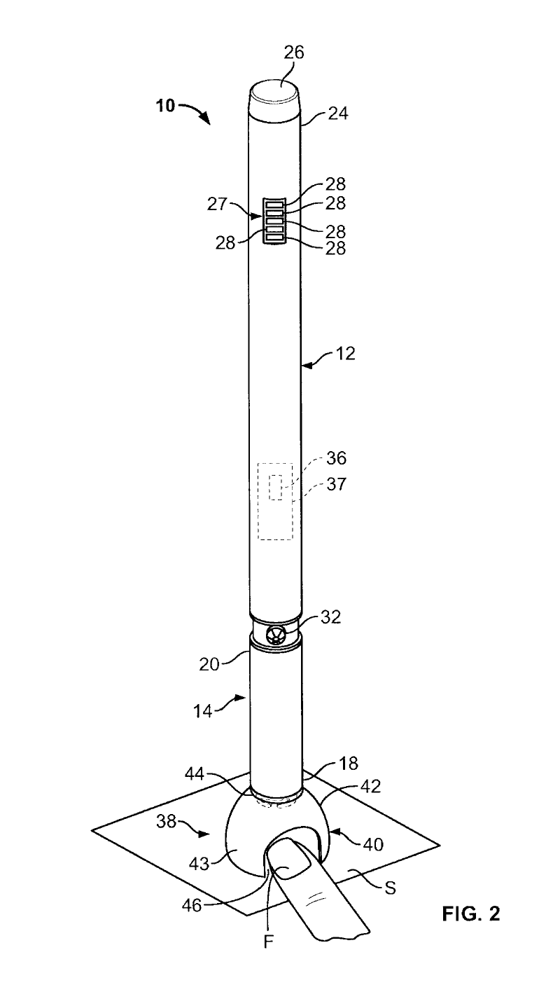

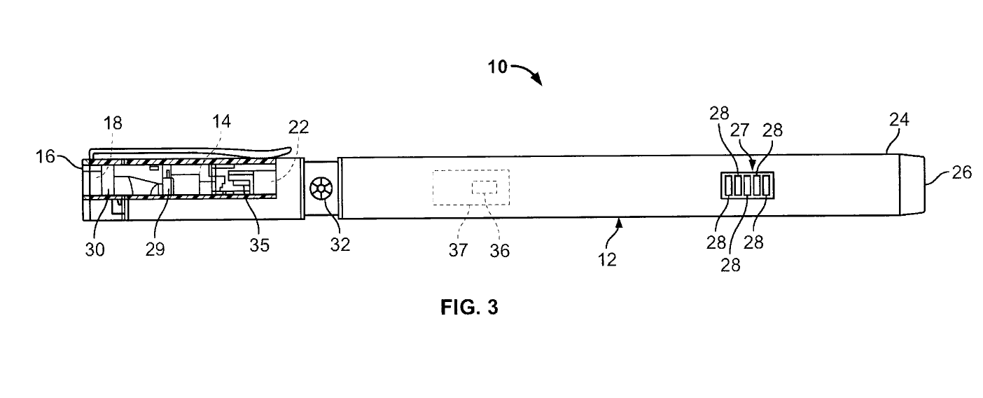

Reference is now made to FIG. 3, which is a side partial sectional view of the UV curing device 10 illustrated in FIGS. 1 and 2, as assembled. The sectional portion illustrates the interior of the UV light source section 14 and the components contained therein. The UV light source section 14 houses a UV light source, such as a UV chip 29, and a lens 30 proximate the first end 18 for generating a focused UV light beam.

As illustrated in FIG. 3, the UV chip 29 is positioned within the UV light source section 14 to project a UV light beam in the direction of the lens 30, which is positioned to be substantially parallel to the UV chip 29. As such, a UV light beam emanating from the UV chip 29 is focused by the lens 30 to form a tightly focused UV light beam. More particularly, the UV light beam emanating from the UV chip 29 has a small beam divergence, and therefore only illuminates a small area of a surface it impacts. In other words, the UV light beam generates a small light field. This feature enables the UV curing device 10 to emit a UV light beam whose impact area, or light field, is generally the size of a human fingernail, and thereby minimizes the UV light exposure beyond the targeted fingernail, e.g., to the skin of the adjacent fingers and/or hand. Sunscreen or similar UV light-blocking substances have been used with known UV light curing devices (such as those described in the Background section above) to minimize such exposure. However, the focused UV light beam of the UV curing device 10 may be directed to one fingernail at a time, and therefore eliminates the need for sunscreen or similar substances to protect the skin of the adjacent fingers and/or hand. The UV curing device 10 may be used to selectively apply UV light to individual desired fingernails, i.e., one at a time. Such an application is performed by holding the UV curing device 10 at an approximate 90° angle to a first surface of a fingernail to target that surface (i.e., to cure the UV gel on that surface), and then repositioning the UV curing device 10 to target other surfaces of the same fingernail by holding it at an approximate 90° angle to such surfaces, as further discussed below.

Referring again to FIGS. 1-3, the UV curing device 10 is provided with an actuator button 32. In one embodiment, the actuator button 32 is positioned on the power supply section 12 proximate the first end thereof 22. In one embodiment, depression of the actuator button 32 completes an electrical circuit between the power supply (e.g., a battery) in the power supply section 12 and the UV chip 29 (or other UV light source) in the UV light source section 14, causing a UV light beam to be emitted from the first end 18 thereof. The operation of the foregoing components (i.e., the actuator button 32, the UV chip 29, the lens 30 and power supply) is described in connection with the UV light devices described in U.S. Pat. Nos. 6,602,074; 6,824,294; 6,926,524; 7,144,250; 7,182,597; 7,345,320; 8,113,831; and/or 8,312,641, and U.S. Patent Application Publication Nos. 2006/0079948 and/or 2012/0161039, the disclosures of all of which are incorporated herein by reference in their entireties.

In one embodiment, a UV light beam is emitted for as long as a user is pressing the actuator button 32. Emission of the UV light beam ceases upon release of the actuator button 32. The actuator button 32 thereby affords the user a maximum level of control of the UV light source, with no timing device being necessary, and performs a safety shut-off function as well. Additional safety features may be incorporated into the design of the UV curing device 10, and are discussed below.

UV light poses a hazard when directed to a human eye. Safety features are therefore incorporated in different embodiments of the present invention, in order to protect against accidental exposure of an eye to UV light.

When the UV curing device 10 is not in use, the cover 16 is removably placed onto the first end 18 of the UV light source section 14, thereby covering the lens 30, as shown in FIG. 3. When the UV curing device 10 is to be used, the cover 16 is removed to expose the lens 30 and allow a UV beam to be directed from the UV curing device 10 to UV gel applied to a fingernail surface. In one embodiment of the invention, the cover 16 is secured to the first end 18 of the UV light source section 14 in a “childproof” manner, so as to prevent accidental use, e.g., by a child, and the resulting inadvertent and potentially harmful eye exposure. In one embodiment, the cover 16 and the first end 18 of the UV light source section 14 are configured to constitute a safety connection, such as the type included in medication bottles that require a combined pushing and turning operation to remove the cap. For example, the first end 18 of the UV light source section 14 may include a slotted circular member 34, as shown in FIG. 1, and the cover 16 may include interior protruding members (not shown) that are sized, shaped and positioned to engage the slots of the circular member 34. When the cover 16 is placed onto the first end 18 of the UV light source section 14, it can be rotated to position the protruding members within the slots of the circular member 34 and thereby “lock” the cover 16 to the first end 18 of the UV light source section 14.

In one embodiment of the invention, the actuator button 32 used to ultimately emit the UV light beam has an associated light circuit 35 (see FIG. 3) that does not function as a simple on/off switch. Rather, multiple (i.e., two or more) independent presses of the actuator button 32 are required to complete the light circuit 35. This may be accomplished, for example, by placing a series of several different switches in the light circuit 35 (each switch comprising a link in the circuit). The light circuit 35 is not completed until all of the switches are pressed. This will protect against an accidental activation and emission of the UV light beam, e.g., by a child, and the resulting inadvertent and potentially harmful eye exposure.

In one embodiment of the invention, three presses of the actuator button 32 are required to complete the light circuit 35 and “unlock” the UV curing device 10. The three unlocking presses may be required within a predetermined time span (e.g., three presses within one second). Once the UV curing device 10 has been unlocked, the actuator button 32 is pressed once to activate the UV light source via the light circuit 35 and emit the UV light beam. In other embodiments, more, or less, than three presses of the actuator button 32 may be used to unlock the UV curing device 10. In one embodiment, the same number of presses of the actuator button 32 (e.g., three presses) may be used to “lock” the UV curing device 10, and thereby prevent the activation of the UV light source, i.e., by pressing the actuator button 32. In other embodiments, only one press of the actuator button 32 is required to unlock and/or lock the curing device 10.

In one embodiment, the light circuit 35 is designed such that the UV curing device 10 becomes locked when a predetermined time span (e.g., five minutes) elapses after the UV curing device 10 is unlocked, as described in the preceding paragraph. For example, a user unlocks the UV curing device 10 by pressing the actuator button 32 three times. Five minutes later, the UV curing device 10 becomes locked, requiring the user to press the actuator button 32 three times to unlock the UV curing device 10 again.

In one embodiment of the invention, operation of the UV curing device 10, i.e., activation of the UV light source via the light circuit 35 to continuously emit the UV light beam, requires first pushing and then holding down the actuator button 32. In other words, once the actuator button 32 is released, emission of the UV light beam from the UV light source ceases. Another safety feature of one embodiment includes an automatic shut-off mechanism, which is deployed after the actuator button 32 has been held down for a continuous predetermined time span (e.g., 10 seconds) to cease emission of the UV light beam from the UV light source.

Once the UV curing device 10 is in use (i.e., once the actuator button 32 has been depressed and the UV light beam is being emitted), there are other safety features which protect against accidentally pointing the UV light beam into the eye of a user or other person. In one embodiment, the UV curing device 10 contains an angular motion sensor 36 (shown in phantom in FIGS. 1-3). An example of one such sensor is the motion and tilt sensor described in U.S. Pat. No. 6,472,864, the disclosure of which is incorporated by reference herein in its entirety. The angular motion sensor 36 is part of an automatic shut-off circuit, or an “integrated protection circuit” 37 (shown in phantom in FIGS. 1-3). If the angular motion sensor 36 senses that the UV curing device 10 is not substantially vertically oriented, it will cause the integrated protection circuit 37 to shut off the UV curing device 10, i.e., cease the emission of the UV light beam therefrom. For example, in proper use, the UV curing device 10 is held at an angle of 90° (or an angle of approximately 90°) with respect to a horizontal surface of a fingernail, such that the UV curing device is substantially parallel to a vertical (or substantially vertical) axis perpendicular to the horizontal fingernail surface. That is, the UV curing device 10 is held in an “upright” position with the lens 30 pointing downward such that it is substantially parallel to a horizontal surface of a fingernail. In this vertical/upright orientation, there is no danger of accidentally pointing the UV curing device 10, and the UV light beam emitting therefrom, into an eye. However, if the user were to rotate the UV curing device 10, e.g., to its side and upwards, there is a danger of accidentally pointing the emitted UV light beam at an eye. In one embodiment, the integrated protection circuit 37 allows the UV curing device 10 to operate only at certain angles to avoid being pointed into an eye if the device is turned towards an eye. For example, in one embodiment of the invention, the UV curing device 10 is operable in a range of 45° to 135° with respect to a horizontal surface of a fingernail. Once the angular motion sensor 36 senses that the UV curing device 10 has been angled to less than 45° or more than 135° with respect to a horizontal surface of a fingernail (i.e., in any radial direction), the integrated protection circuit 37 automatically ceases the emission of the UV light beam, and/or deactivates the UV curing device 10. The actuator button 32 must then be pressed again in order to emit the UV light beam and/or activate the UV curing device 10.

In another embodiment of the invention, the UV curing device 10 contains a reflectivity sensor (not shown) to determine whether or not the substrate upon which the UV light beam is directed is, in fact, a fingernail. That is, an eye will have different reflective properties from those of a fingernail. The reflectivity sensor measures a reflective response and determines whether or not the substrate is a fingernail or an eye, based on the measured reflective properties. If the substrate upon which the emitted UV light beam is directed is an eye, emission of the UV light beam is automatically ceased, and/or the UV curing device 10 is deactivated.

In other embodiments of the invention, the actuator button 32 may be illuminated, with different flashing sequences of light and/or different colors of light (e.g., LEDs) to signal to a user various operational states. For example, depressing the actuator button 32 to emit the UV light beam, depressing it again to cease emission of the UV light beam, automatically locking the UV curing device 10, unlocking the UV curing device 10, and a low battery alert may all be signaled by the actuator button 32 illuminating different colors and/or with different flashing sequences of light.

Referring again to FIG. 2, a shield 38 may be provided for use with the UV curing device 10. In one embodiment, the shield 38 includes a substantially dome-shaped body 40 having a top portion 42 and a bottom portion 43. The top portion 42 defines an aperture 44 in a substantially horizontal plane, and the body 40 defines an opening 46 proximate the bottom portion 43 of the shield 38 and an underlying surface S (e.g., a manicurist's table or cosmetics counter). The aperture 44 is sized and shaped so as to receive the first end 18 of the UV light source section 14 and the lens 30 therein. The opening 46 of the shield 38 is sized and shaped so as to allow insertion of a fingernail F, and the proximate section of the finger, therein. Once a fingernail is inserted into the opening 46, and the first end 18 of the UV light source section 14 and the lens 30 are secured within the aperture 44, the UV curing device 10 may be activated to emit a UV light beam and cure the UV gel on the fingernail F.

The shield 38 serves a safety function, in that it is formed from either an opaque material or a translucent material having a UV filter therein, and thereby blocks the transmission of the UV light beam emitted from the UV curing device 10. More particularly, a portion of the UV light beam emitted from the UV curing device 10 may inadvertently be directed into the surface S (which is often formed from a reflective material), and reflected by the surface S back towards a user's eye. When formed from one of the foregoing materials, the shield 38 blocks the transmission of the reflected UV light beam, and thereby protects the user's eyes therefrom.

Usage of the UV curing device 10 according to an embodiment will now be described, with reference to FIG. 2. The UV curing device 10 may be used by a manicurist, or by a user to cure UV gel on her own fingernails. UV gel is applied to a first target fingernail F, which is then placed into shield 38 via the opening 46. The UV curing device 10 is then positioned such that the first end 18 of the UV light source section 14 and the lens 30 engage the aperture 44. Once the UV curing device 10 is secured in a substantially vertical position, the actuator button 32 is depressed (e.g., three times) to unlock the UV curing device 10, and again to emit the UV light beam, as described above. The UV light beam cures the UV gel on the fingernail F. The finger may be rotated within the shield 38 such that the UV gel on all of the surfaces of the fingernail F are cured by the UV light beam emitted from the UV curing device 10. Once the UV gel on the fingernail F has been cured, the fingernail F is removed, and a second target fingernail may be inserted in the opening 46, and the UV curing device 10 may be used to cure the UV gel on the surface(s) of a second target fingernail, repeating the foregoing steps performed in connection with the first target fingernail F. The process may be continued for additional fingernails, to sequentially, separately and individually apply UV light to each of a plurality of fingernails using the UV curing device 10.

In another embodiment, the UV curing device 10 may be used to cure UV gel on the fingernail without using the shield 38. The UV curing device 10 is positioned proximate a first target fingernail having UV gel on at least one surface thereof. As discussed above, the UV curing device 10 is held at an angle of 90° (or an angle of approximately 90°) with respect to a horizontal surface of the first target fingernail, such that the UV curing device is substantially parallel to a vertical (or substantially vertical) axis perpendicular to the horizontal fingernail surface. The UV curing device 10 is then activated by pressing the actuator button 32 such that the UV light source (i.e., the UV chip 29) emits a focused UV light beam in the direction of the surface of the first target nail to cure the UV gel on that surface. As described above, the focused UV light beam has an impact area, or light field, that is generally the size of a human fingernail, and thereby minimizes the UV light exposure beyond the targeted fingernail, e.g., the skin of the adjacent fingers and/or hand. The focused UV light beam of the UV curing device 10 is therefore selectively directed to only the first target fingernail. In other words, the focused UV light beam individually contacts the surface of the first target nail to cure the UV gel without contacting other fingernails, or adjacent skin (i.e., of the fingers and/or hand). Once the UV gel is cured, the UV curing device 10 may be deactivated, e.g., by pressing the actuator button 32.

The UV curing device 10 may then be used to cure the UV gel on a second surface of the first target fingernail. Fingernails are curved, and may therefore possess more than one surface. The steps described in the foregoing paragraph are repeated for the second surface of the first target fingernail, and then for any additional surfaces thereof.

After the UV gel on all of the surfaces of the first target fingernail have been cured, the UV curing device 10 may be used to cure the UV gel on the surface(s) of a second target fingernail, repeating the foregoing steps performed in connection with the first target fingernail. The process may be continued for additional fingernails, to sequentially, separately and individually apply UV light to each of a plurality of fingernails using the UV curing device 10.

The relatively small “handheld” size of the UV curing device 10 facilitates positioning it so as to be substantially parallel to a vertical (or substantially vertical) axis perpendicular to the horizontal fingernail surface, regardless of the orientation of the fingernail surface. For example, a thumbnail surface will have a different orientation, than the surfaces of other fingernails, when the hand is laid palm-down. A user can easily position and reposition the UV curing device 10 to adjust to the orientation of various fingernail surfaces, unlike conventional table-top UV curing devices discussed above in the Background section.

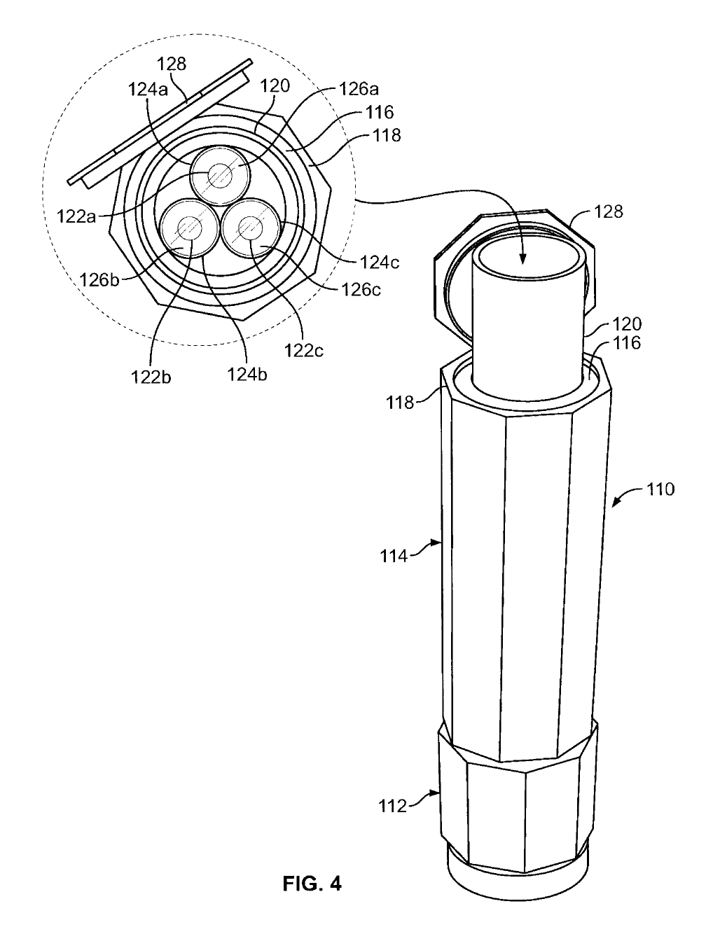

Another embodiment according to the present invention is illustrated in FIG. 4, in which a UV curing device 110 is designed to appear and operate like a lipstick container with a retractable applicator, such as those described in U.S. Pat. Nos. 1,849,531; 2,352,448; 2,442,109; 2,444,375; 2,636,598; 6,200,049; 6,412,999; 7,500,799; and/or 8,267,606, the disclosures of which are all incorporated by reference herein in their entireties. As shown in FIG. 4, a UV curing device 110 is provided in the shape of a lipstick container, and includes a base section 112 and a UV light source section 114 rotatably connected to the base section 112. In one embodiment, the base section 112 functions as a power supply section similar to the power supply section 12 of the UV curing device 10 shown in FIGS. 1-3. In another embodiment, the UV light source section 114 also functions as a power supply section, similar to the power supply section 12 of the UV curing device 10 shown in FIGS. 1-3. Either the base section 112 or the UV light source section 114 may receive one or more conventional, one-time use batteries, or a built-in rechargeable battery. Unless otherwise indicated below, the UV curing device 110 may include the same components and perform the same functions as those disclosed above in connection with the UV curing device 10.

With continued reference to FIG. 4, the UV light source section 114 defines an opening 116 at an end 118 distal to the base section 112. The UV light source section 114 is an elongated tube, and contains a substantially cylindrical housing 120 therein. As in conventional lipstick containers, e.g., those disclosed in the aforementioned patents, the housing 120 is telescopically disposed within the UV light source section 114 so as to be rotatably moveable along an axis defined by the length of the UV light source section 114. Rotation of the base section 112 in one direction (e.g., counterclockwise) upwardly advances the housing 120 towards and at least partially outside of the opening 116. Rotation of the base section 112 in the opposite direction (e.g., clockwise) downwardly advances (i.e., retracts) the housing 120 back into the UV light source section 114.

In one embodiment of the UV curing device 110, the housing 120 of the UV light source section 114 contains a plurality of UV light sources (i.e., UV chips) rather than a single UV light source. In the embodiment illustrated in FIG. 4, the UV source section 114 contains three UV chips 122a, 122b, 122c, each of which is contained in its own respective compartment 124a, 124b, 124c. Each compartment 124a, 124b, 124c also contains a lens 126a, 126b, 126c, respectively, for generating a focused light beam. As illustrated in FIG. 4, the UV chips 122a, 122b, 122c are positioned within the respective compartments 124a, 124b, 124c to project UV lights beam in the direction of the lenses 126a, 126b, 126c, which are positioned to be substantially parallel to the respective UV chips 122a, 122b, 122c. As such, UV light beams emanating from the UV chips 122a, 122b, 122c are focused by the lenses 126a, 126b, 126c, to form tightly focused UV light beams. Other embodiments of the UV curing device 110 may include fewer or more UV chips and lenses. In other embodiments, more than one lens may be used with a single UV chip. In another embodiment, the lens and UV chips are not separated into individual compartments. It will be understood that there may be any of various numbers and configurations of lenses and UV chips in different embodiments of the invention.

The UV curing device 110 includes a lid 128 pivotally attached to the end 118 of the UV light source section 114, proximate the opening 116 (see FIG. 4), such that the lid 128 may be opened and closed by with the rotation of the base section 112. The lid 128 may be attached to the end 118 by means of a hinge (not shown). Alternatively, the lid 128 and the UV light source section 114 could be made in one piece with the hinge provided by a living hinge. The lid 128 is pushed up and opened by the upward motion of the housing 120 upon rotation of the base section 112 in one direction, as described above. The lid 128 is spring-loaded, such that it closes automatically upon the downward motion of the housing 120 upon rotation of the base section 112 in an opposite direction, as also described above. In one embodiment, the structure and operation of the lid 128 is described in connection with the device of U.S. Pat. No. 8,267,606, the disclosure of which is incorporated by reference herein in its entirety.

The UV curing device 110 includes an actuator button, which, in one embodiment, is disposed on the bottom of the base section 112, distal to the UV light source section 114 (not shown). The actuator button may be disposed on other parts of the UV curing device 110 in other embodiments thereof. The actuator button functions in the same manner as the actuator button 32 described above in connection with the UV curing device 10. Further, any and/or all of the safety features disclosed above in connection with the UV curing device 10 of FIGS. 1-3 may also be incorporated in the UV curing device 110.

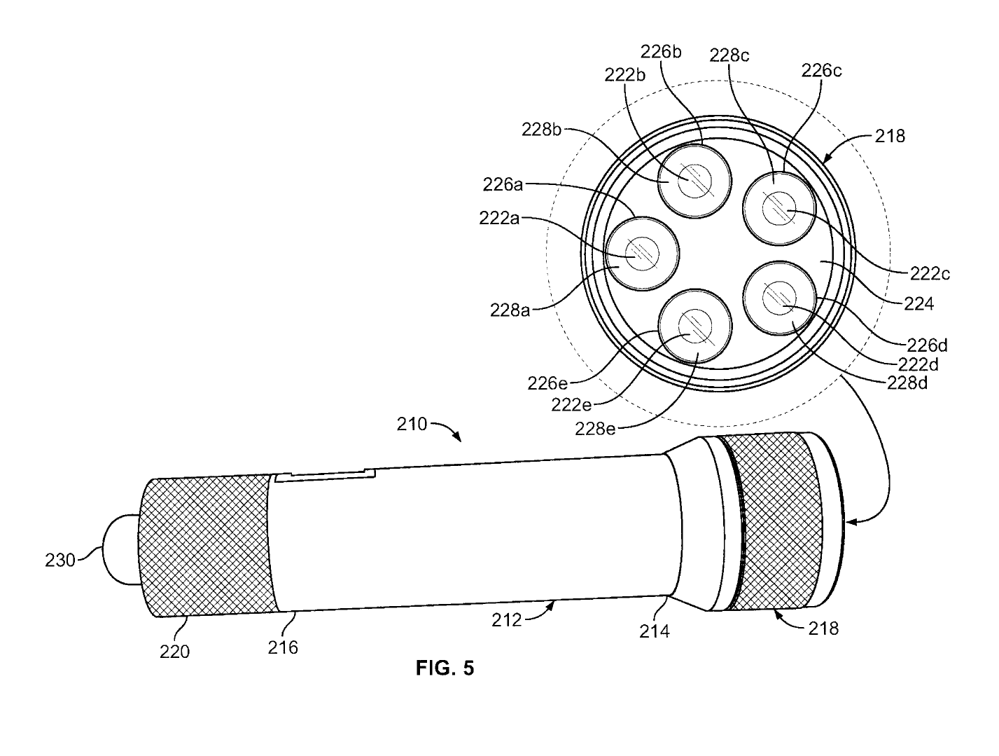

Another embodiment according to the present invention is illustrated in FIG. 5, in which a UV curing device 210 is designed to appear and operate like a small flashlight. Unless otherwise indicated below, the UV curing device 210 includes the same components and performs the same functions as those disclosed above in connection with the UV curing device 10 of FIGS. 1-3 and/or the UV curing device 110 of FIG. 4.

As illustrated in FIG. 5, the UV curing device 210 includes a tubular power supply section 212, which may be similar to the power supply section 12 of the UV curing device 10, and which has first and second ends 214, 216. The supply section 212 may receive one or more conventional, one-time use batteries, or a built-in rechargeable battery. The UV curing device 210 also includes a UV light source section 218, which houses one or more UV light sources (as discussed below) and is secured to the first end 214 of the power supply section 212, and an end cap 220, which is secured to the second end 216 of the power supply section 212. In some embodiments, the UV light source section 218 and/or the end cap 220 are removeably attached to the power supply section 212 at its respective ends, wherein the UV light source section 218 and/or the end cap 220 may be removed to replace used batteries, or access a charging jack for charging a rechargeable battery.

In one embodiment of the UV curing device 210, the UV light source section 218 contains a plurality of UV light sources (e.g., UV chips) rather than a single UV light source. In the embodiment illustrated in FIG. 5, the UV source section 218 contains five UV chips 222a, 222b, 222c, 222d, 222e. An equatorial plate 224 having five apertures 226a, 226b, 226c, 226d, 226e is positioned inside the UV light source section 218 proximate the UV chips 222a, 222b, 222c, 222d, 222e therein. Each aperture 226a, 226b, 226c, 226d, 226e is sized and shaped so as to enclose a lens 228a, 228b, 228c, 228d, 228e, respectively. In one embodiment, a single UV light source (e.g., each of the UV chips 222a, 222b, 222c, 222d, 222e) is positioned behind each of the respective lenses 228a, 228b, 228c, 228d, 228e. As illustrated in FIG. 5, the UV chips 222a, 222b, 222c, 222d, 222e are positioned proximate the equatorial plate 224 to project UV lights beams in the direction of the lenses 228a, 228b, 228c, 228d, 228e, which are positioned to be substantially parallel to the respective UV chips 222a, 222b, 222c, 222d, 222e. As such, UV light beams emanating from the UV chips 222a, 222b, 222c, 222d, 222e are focused by the lenses 228a, 228b, 228c, 228d, 228e, to form tightly focused UV light beams. Other embodiments of the UV curing device 210 may include fewer or more UV chips and lenses. In other embodiments, more than one lens may be used with a single UV chip. It will be understood that there may be any of various numbers and configurations of lenses and UV chips in different embodiments of the invention.

The UV curing device 210 includes an actuator button 230, which, in one embodiment, is disposed on the end cap 220, distal to the power supply section 212. The actuator button 230 may be disposed on another part of the UV curing device 210 in other embodiments thereof. The actuator button 230 functions in the same manner as the actuator button 32 described above in connection with the UV curing device 10 of FIGS. 1-3. Further, any and/or all of the safety features disclosed above in connection with the UV curing device 10 may also be incorporated in the UV curing device 210.

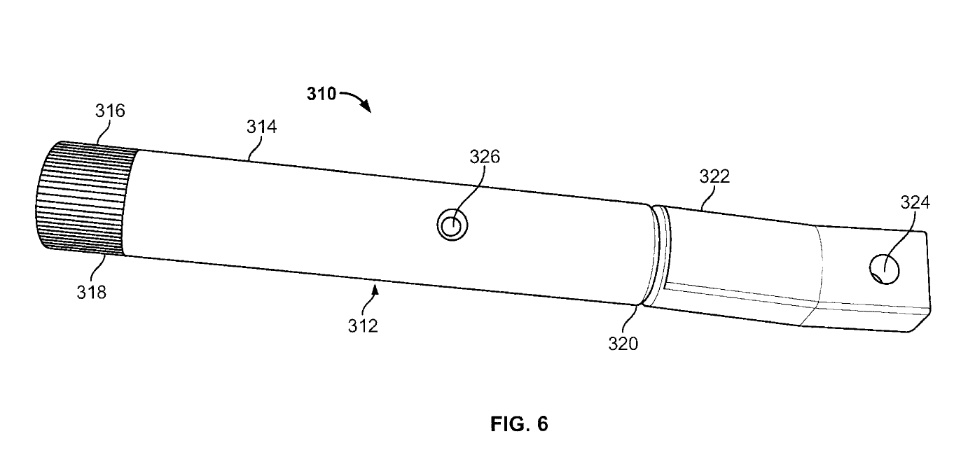

Another embodiment of the UV curing device 310 is illustrated in FIG. 6. Unless otherwise indicated below, the UV curing device 310 includes the same components and performs the same functions as those disclosed above in connection with the UV curing device 10, the UV curing device 110, and/or the UV curing device 210.

As illustrated in FIG. 6, the UV curing device 310 includes a tubular body 312, which, in one embodiment, may include both a power supply section 314 and a UV light source section 316. The tubular body 312 has first and second ends 318, 320. The power supply section 314 may receive one or more conventional, one-time use batteries, or a built-in rechargeable battery. The UV light source section 316 houses one or more UV light sources (not shown). An end piece 322 is secured to the second end 320 of the tubular body 312, and may define an aperture 324 therein, i.e., for attaching a key ring or chain to the UV curing device 310.

In some embodiments, the UV light source section 316 and/or the end piece 322 are removeably attached to the power supply section 314 at its respective ends, wherein the UV light source section 316 and/or the end piece 322 may be removed to replace used batteries, or access a charging jack for charging a rechargeable battery.

The UV curing device 310 includes an actuator button 326, which, in one embodiment, is disposed on the side of the body 312, i.e., on the surface of the power supply section 314. The actuator button 326 may be disposed on another part of the UV curing device 310 in other embodiments thereof. The actuator button 326 functions in the same manner as the actuator button 32 described above in connection with the UV curing device 10. Further, any and/or all of the safety features disclosed above in connection with the UV curing device 10 may also be incorporated in the UV curing device 310.

It will be understood that the embodiments described herein are merely exemplary and that a person of ordinary skill in the art may make many variations and modifications without departing from the spirit and scope of the invention. All such variations and modifications are intended to be included within the scope of the invention as defined in the appended claims. One such modification includes the use of the UV curing devices and/or associated methods disclosed above in connection with pedicures involving UV gel applied to toenails.

1-4. (canceled)

5. A UV curing device, comprising:
a UV light source;
control means for actuating said UV light source; and
a reflectivity sensor operatively connected to said UV light source for minimizing inadvertent pointing of a UV light beam from said UV light source into an eye, wherein said reflectivity sensor is configured to measure the reflective response of a substrate onto which said UV light source emits a UV light beam, and ceases the operation of said UV light source upon receiving and measuring a predetermined reflective response.

6. The UV curing device of claim 5, wherein said predetermined reflective response corresponds to the reflection off of an eye.

7. A UV curing device, comprising:
a UV light source;
control means for actuating said UV light source; and
a shield capable of blocking the transmission of UV light so as to minimize transmission of a UV light beam from said UV light source to an eye, said shield being configured to receive said UV light source.

8. The UV curing device of claim 7, wherein said shield includes a body having a top portion and a bottom portion, wherein said top portion defines an aperture therein, said aperture being sized and shaped so as to receive said UV light source.

9. The UV curing device of claim 8, wherein said body defines an opening proximate said bottom portion of said shield, said opening being sized and shaped so as to receive a single human finger therein for curing UV gel applied on the finger.

10. The UV curing device of claim 7, wherein said shield is formed from one of an opaque material and a translucent material having a UV filter therein.

11. A UV curing device, comprising:
a UV light source; and
control means for actuating said UV light source, wherein said control means includes an actuator button and an associated light circuit operatively connected to said UV light source and configured to activate said UV light source when said actuator button is pressed a predetermined number of times.

12. The UV curing device of claim 11, wherein said predetermined number of times is at least two.

13. The UV curing device of claim 12, wherein said associated light circuit includes a series of switches, whereby said UV light source is activated once all of said switches are deployed.

14. A method for curing UV gel on a plurality of nails, the method comprising the steps of:
positioning a UV curing device proximate a first target nail of the plurality of nails having UV gel on at least one surface thereof, said UV curing device containing a UV light source;
activating said UV curing device such that said UV light source emits a focused UV light beam in the direction of the at least one nail surface, wherein said focused UV light beam individually contacts the at least one nail surface of the first target nail to cure the UV gel without contacting other nails of the plurality of nails or adjacent skin;
positioning said UV curing device proximate a second target nail of the plurality of nails having UV gel on at least one surface thereof; and
activating said UV curing device such that said UV light source emits a focused UV light beam in the direction of the at least one nail surface of the second target nail, wherein said focused UV light beam individually contacts the at least one nail surface of the second target nail to cure the UV gel without contacting other nails of the plurality of nails or adjacent skin.

15. The method of claim 14, further comprising the steps of:
removeably attaching a shield capable of blocking the transmission of UV light to said UV light source; and wherein
said step of positioning said UV curing device proximate the first target nail includes the step of inserting the first target nail within said shield, and
said step of positioning said UV curing device proximate the second target nail includes the step of inserting the second target nail within said shield.

16. The method of claim 14, wherein said UV curing device includes a reflectivity sensor operatively connected to said UV light source for minimizing inadvertent pointing of a UV light beam from said UV light source into an eye, wherein said reflectivity sensor is configured to measure the reflective response of a substrate onto which said UV light source emits a UV light beam, and ceases the operation of said UV light source upon receiving and measuring a predetermined reflective response.

17. The method of claim 14, wherein said UV curing device includes control means for actuating said UV light source, wherein said control means includes an actuator button and an associated light circuit operatively connected to said UV light source and configured to activate said UV light source when said actuator button is pressed a predetermined number of times.
